(19) United States
(12) Patent Application Publication
(10) Pub. No.: US 2021/0260542 A1
(43) Pub. Date: Aug. 26, 2021

(54) MIXING DEVICE FOR PROVIDING A READY-TO-USE COMPOUND, AND WORKING METHOD FOR SAME

(71) Applicant: Heina Meyer, Walsrode (DE)

(72) Inventor: Heina Meyer, Walsrode (DE)

(21) Appl. No.: 17/268,196

(22) PCT Filed: Aug. 13, 2019
(86) PCT No.: PCT/DE2019/100726

§ 371 Date: Feb. 12, 2021

(30) Foreign Application Priority Data
Aug. 20, 2018 (DE) 20 2018 104 763.9

(51) Int. Cl. B01F 11/00; B01F 13/00; B01F 15/00; B01F 7/00; B01F 7/16

(52) U.S. Cl. CPC B01F 11/0054; B01F 11/0082; B01F 13/0023; B01F 2215/0039; B01F 7/00725; B01F 7/1695; B01F 15/00772; B01F 15/00746

(57) ABSTRACT

A mixing device for preparing a ready-to-use compound comprising at least one component, which is to be mixed before use, in a cartridge with a tubular mixing rod and a working method with this mixing device and cartridge. The insertion of the cartridge in the mixing device is simplified so that the device can be operated completely automatically, and dispensing of a cartridge to be mixed or a ready-mixed cartridge is preferably be made possible with automated handling means (robots). Because the cartridge holder has a clamping means with which the cartridge can be clamped on the bottle neck-like section, the clamping of the cartridge in the mixer is simplified and can be triggered by force, for example pneumatically.

The invention relates to a mixing device for preparing a ready-to-use compound comprising at least one component, which is to be mixed before use, in a cartridge with a tubular mixing rod and a working method with this mixing device and cartridge.

Cartridges, in particular two-component or multi-component cartridges with the features mentioned above, are generally known in the prior art. Reference is made, for example, to DE 198 28 351 A1, U.S. Pat. Nos. 3,735,900 and 6,213,631 B1.

Such cartridges are used to prepare and dispense a usable sealing compound, adhesive compound, potting compound or the like; one-component compounds that are heterogeneous or inhomogeneous can be mixed or homogenized before they are used. In the case of two- or multi-component compounds, a basic component is stored in a storage and mixing space and, for example, a hardener is stored separately from the basic component in the tubular mixing rod.

From CH 440 897 A a device for transmitting a reciprocating movement of a drive element to an impeller in a conditioning container is known, in which the rotary movement is achieved by a helical rotation of a flat profile in a corresponding guide.

EP 1 994 977 A1 discloses an automatic mixer for injecting and mixing an accelerating agent into a cartridge containing a starting agent with filler, the accelerating agent being contained in a hollow rod equipped with an injection and mixing head.

Furthermore, EP 2 193 836 A1 describes a device for mixing a plastic material with a dye, in which a mixing chamber is provided in which two components can be mixed and the compounds to be mixed can be pressurized with a piston.

From EP 2 916 695 B1 a food homogenization device is known which comprises a drive arrangement and a homogenization arrangement in which the product to be homogenized is accommodated in a cassette.

Furthermore, EP 0 407 805 A1 discloses a method and a device for mixing, in particular dental impression materials, which are mixed in a rotation and/or extrusion device immediately before application and are injected from there.

The mixing device described initially is known from DE 20 2005 005 150 U1. The cartridge holder is designed in such a way that the cartridge with its cylindrical storage and mixing space is inserted upside down into this cartridge holder in a corresponding cylindrical holder with the mixing rod first, with a small edge of the cartridge away from the mixing rod resting on a surrounding seat. The cartridge is then firmly clamped with this small edge in the cartridge holder by a clamping piece via a bayonet lock. A pneumatic cylinder is provided in this clamping piece, which loads a pressure ram onto the compensating piston of the storage and mixing space of the cartridge.

An automatic control for mixing stroke movements in such a mixing device is described in DE 297 08 716 U1.

Furthermore, at the other end of the cartridge, at the outward end of the mixing rod, care must be taken that the coupling element provided there is held by the device in such a way that the push rod can be inserted coaxially into the mixing rod.

These processes are laboriously carried out manually, which means that an appropriately trained operator must always work on the device.

The object of the invention is therefore to simplify the insertion of the cartridge in a mixing device analogous to DE 20 2005 005 150 U1, in particular to be able to operate it completely automatically. The insertion and dispensing of a cartridge to be mixed or a ready-mixed cartridge should preferably be made possible with automated handling means (robots).

This object is achieved with a mixing device according to claim 1.

Because the cartridge holder has a clamping means with which the cartridge can be clamped on the bottle neck-like section, the clamping of the cartridge in the mixer is simplified and can be triggered by force, for example pneumatically.

If the clamping means have two pliers jaws pivotable about a hinge with receptacles for the bottle neck-like section, the cartridge can be fed laterally to the clamping means without critical handling of the elongated cartridge with the mixing rod from one end. The cartridge can, for example, be gripped by a robot at the cylindrical storage and mixing space and introduced radially to the axis of the joint with its longitudinal axis between the jaws of the clamping device. The jaw pliers preferably have approximately semi-cylindrical receptacles for the bottle neck-like section. Of course, the receptacles can also be designed prismatic or polygonal in order to be able to securely grasp the bottle neck-like section of the cartridge.

If a first proximity sensor is arranged on the clamping means, which can detect the approach of a cartridge and trigger the clamping of the cartridge, the clamping of the cartridges can be automated with a corresponding feeding of the cartridge.

In order to be able to mix two- or multi-component compositions with the mixer, at least one component is accommodated in the storage and mixing space and the other component is accommodated in the tubular mixing rod, with a push rod insertable into the tubular mixing rod, a push rod holder for holding the push rod and one for the push rod holder associated push-in cylinder provided for pushing the push-in rod into the tubular mixing rod.

The fact that the holder for the coupling element of the mixing rod has at least two, preferably three clamping arms, which are designed to be clamped around the plate-shaped coupling element in order to be able to transmit a torque to the mixing rod, also simplifies the plate-shaped coupling element and thus the rotary drive of the mixing rod in such a way that that handling by robots is possible. The preferred three clamping arms encircle the plate-shaped coupling element in such a way that a torque can be transmitted to the mixing rod.

If the clamping arms are designed so that they can be clamped around the plate-shaped coupling element about swivel axes arranged tangentially to the axis of rotation oriented coaxially to the mixing rod, a high holding force on the plate-shaped coupling element and thus reliable torque transmission can be ensured. Of course, the pivot axes for the clamping arms can also be oriented slightly adjusted relative to the tangential direction to the axis of rotation, whereby a secure clamping of the plate-shaped coupling element for torque transmission is still possible. If the clamping arms are designed to be actuatable with a second pneumatic cylinder, the clamping forces can be generated pneumatically.

In order to automate the clamping process in a structurally simple manner, a second proximity sensor is arranged on the holder for the coupling element of the mixing rod, which can detect the approach of the coupling element to a cartridge and trigger the clamping of the plate-shaped coupling element.

An exemplary embodiment of the invention is described in detail below with reference to the accompanying drawings.

Therein:

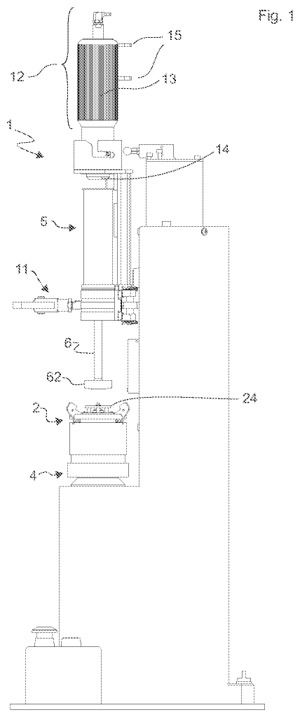

FIG. 1 shows a mixing device with a not yet clamped cartridge in a side view,

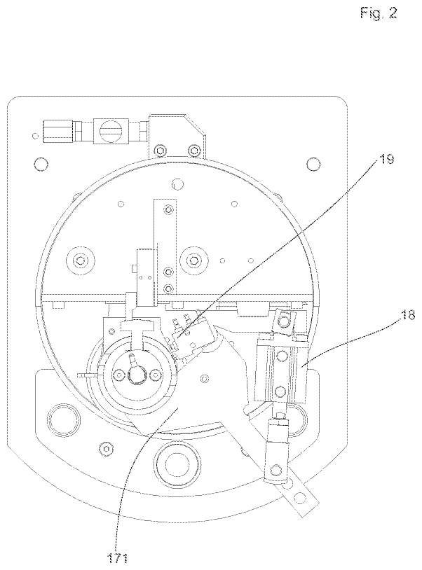

FIG. 2 shows this situation in plan view,

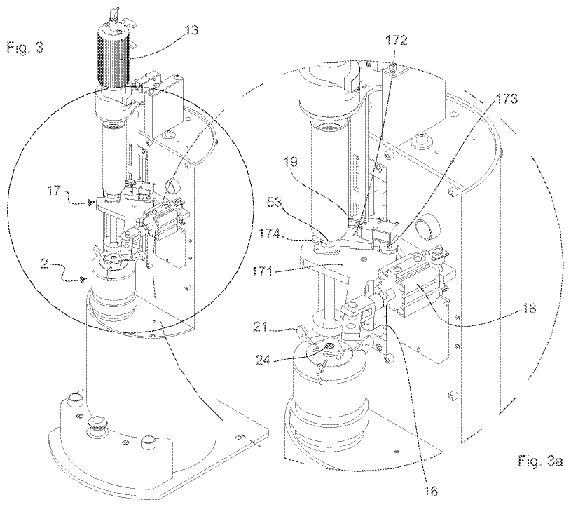

FIG. 3 shows this situation in a spatial view, while

FIG. 3a shows an enlarged detailed view,

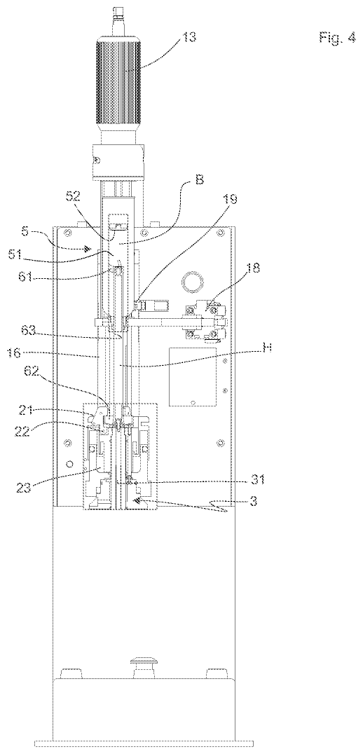

FIG. 4 shows a partially sectioned representation of a front view of the mixing device with a firmly clamped cartridge and

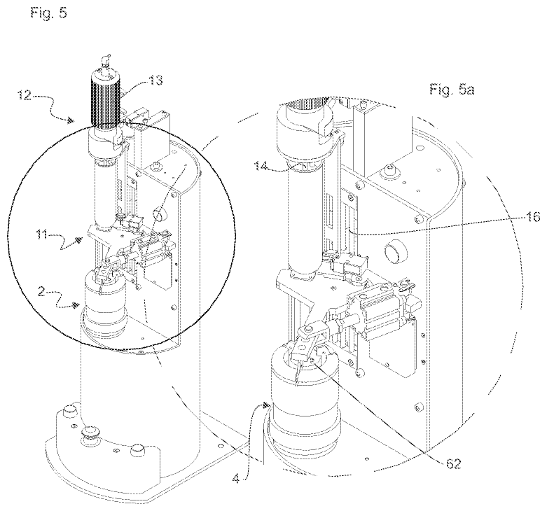

FIG. 5 shows this situation in a spatial view while

FIG. 5a shows an enlarged detailed view.

In FIG. 1, a mixing device for preparing a ready-to-use sealing compound or adhesive compound is shown in a side view. A cartridge 5 is positioned in the mixer, but not yet clamped. The cartridge 5 has a storage and mixing space 51 with a compensating piston 52 (see FIG. 4), in which a first component (basic component B) of the composition to be prepared is received. In FIG. 4 it can be seen in the partially sectioned representation that the cartridge 5 has a bottle neck-like section 53 at its downwards pointing end, in which a tubular mixing rod 6 is guided rotatably and laterally displaceable. In the basic position, the cartridge 5 is to be fed to the mixer with a far protruding tubular mixing rod 6. At its end oriented in the storage and mixing space 51, the tubular mixing rod 6 has a mixing head 61 which ensures that when the mixing rod 6 is rotated, the composition received in the storage and mixing space 51 is mixed. A plate-shaped coupling element 62 is provided at the outward end of the tubular mixing rod 6. The other component, for example a hardener H, is received in the tubular mixing rod 6.

The mixing device has a cartridge holder 1 for inserting the cartridge 5 to be prepared. The cartridge holder 1 has a lower receptacle 11, which has a clamping means 17 with which the cartridge 5 can be clamped at the bottle neck-like section 53. In FIG. 3 and in detail in FIG. 3a, the mixer is shown with the clamping means 17 still open. The clamping means 17 has two pliers jaws 171, 172 which can be pivoted relative to one another about a joint 173. Semi-cylindrical receptacles 174 are provided in the first clamping jaw 171 and the second clamping jaw 172, so that the bottle neck-like section 53 of the cartridge 5 can be securely clamped and held by the clamping means 17.

To actuate the clamping means 17, a first pneumatic cylinder 18 is provided, which in the illustrated embodiment (see in particular FIG. 2) can adjust the second clamping jaw 172 relative to the first clamping jaw 171 about the joint 173. In order to automate the clamping of the cartridge 5 at its bottle neck-like section 53 in the clamping means 17, a first proximity sensor 19 is provided on the clamping means 17. This recognizes the introduction of the bottle neck-like section 53 of the cartridge 5 into the clamping means 17, as shown in FIGS. 1, 2 and 3 as well as 3a, and closes the first pneumatic cylinder 18 for clamping the cartridge 5 with compressed air applied, i.e. the clamping device 17.

Furthermore, the cartridge holder 1 has an upper element 12 on which a counter-pressure cylinder 13 is provided with a counter-pressure plate 14 connected to it. This upper element 12 of the cartridge holder 1 lies just above the cartridge 5 to be inserted, so that after the cartridge 5 has been inserted in the mixer, the counter-pressure cylinder 13 can be activated and its counter-pressure plate 14 can bear against the compensating piston 52 in the cartridge 5. Against the counter-pressure plate 14, switching cams 15 are provided on the upper element 12 of the cartridge holder 1 to control the stroke movement of the mixing rod to conform to the size of the cartridge used for complete mixing of the composition received in the cartridge 5 in the storage and mixing space 51 by the mixing head 61 of the tubular mixing rod 6.

Furthermore, a fixedly arranged holder 2 for the plate-shaped coupling element 62 of the mixing rod 6 is provided on the mixing device, on which the mixing rod 6 is rotatably received but fixed in the longitudinal direction. For this purpose, three clamping arms 21 are provided on the holder 2, which are oriented around pivot axes 22 which are tangential to the longitudinal axis of the cartridge 5 or the axis of rotation of the device. The three clamping arms 21 can be pivoted in a force-operated manner about these pivot axes 22 via a second pneumatic cylinder 23.

Furthermore, a second proximity sensor 24 is provided on the holder 2, which activates the second pneumatic cylinder 23 for clamping the plate-shaped coupling element 62 by the clamping arms 21 upon approach of the plate-shaped coupling element 62 of the tubular mixing rod 6.

If the lower end of the tubular mixing rod 6, i.e. the plate-shaped coupling element 62, does not rest on the holder 2 when the cartridge 5 is inserted, this is immediately brought about by a first actuation of a mixing stroke cylinder 16, i.e. a downward movement of the entire cartridge holder 1 with the cartridge 5 received therein and the tubular mixing rod 6 protruding downward therefrom (see FIG. 5 and in detail FIG. 5a).

As soon as the plate-shaped coupling element 62 touches the holder 2, and the second proximity sensor 24 causes the three clamping arms 21, by means of a second pneumatic cylinder 23, to securely hold the plate-shaped coupling element 62, a push-in rod 31 held in a push-in rod receptacle 3 is pushed in from below (below the holder 2) by means of a push-in cylinder (not shown) into the tubular mixing rod 6 and thus a component received there in a sealed section 63 of the tubular mixing rod 6, for example the hardener H, is injected into the storage and mixing space 51. The insertion rod 31 of the insertion rod receptacle 3 is withdrawn again after the other component H has been introduced. The increase in volume in the storage and mixing space 51 due to the pressing in of the second component H is compensated for by the counter-pressure cylinder 13 with the counter-pressure plate 14. Likewise, changes in volume during the mixing process are compensated for by the evenly loaded counter-pressure cylinder 13.

The mixing process now takes place pneumatically actuated via the mixing stroke cylinder 16 and rotary drive of the holder 2 by means of, for example, a pneumatic drive means 4. The switching cams 15 with associated switching valves for the pneumatic mixing stroke cylinder 16 effect a complete mixing of the storage and mixing space 51 with the two components B and H now accommodated thereon, while the pneumatic drive means 4, via clamping by means of three clamping arms 21 of the holder 2, effect the rotary movement on the mixing rod 6 and thus the mixing head 61.

After the required mixing cycles have been carried out, the clamping arms 21 are opened by releasing the second pneumatic cylinder 23 so that the plate-shaped coupling element 62 of the mixing rod 6 is freed and the upper element 12 of the cartridge holder 1 with its counter-pressure cylinder 13 and counter-pressure plate 14 is lifted out of the cartridge 5. Subsequently the clamping means 17 is opened as soon as the cartridge 5 is gripped, for example, by a robot arm. The robot can now convey the ready-to-use prepared sealant or adhesive in the cartridge 5 to the application device.

The design of a clamping means 17 with semi-cylindrical receptacles 174 on a first clamping jaw 171 and a second clamping jaw 172 advantageously enables a secure and easy-to-use clamping option for the cartridge 5 on the bottle neck-like section 51. Robots can thus also handle the cartridges, namely feeding the cartridge to the mixing device and removing ready-made cartridges from the mixing device.

In addition, the holder 2 provided with clamping arms 21 can also automate the transmission and clamping of the mixing rod 6 by means of the plate-shaped coupling element 62.

With the mixing device according to the application, sealing compounds or adhesive compounds made of at least two components can be mixed reliably and with constant quality and thus prepared for use, with the feeding and removal of the cartridges being highly automated and carried out, for example, by robots. Laborious and manual insertion of the cartridges into the previously known mixing devices with manual clamping of the cartridge by inserting the upper element into a bayonet guide and aligning the cartridge with the tubular mixing rod with respect to the holder 2 is therefore no longer necessary. The movement sequences can be carried out safely with conventional robots.

### LIST OF REFERENCE NUMBERS

1 cartridge holder
11 lower receptacle
12 upper element
13 counter pressure cylinder
14 counter pressure plates
15 switching cams
16 mixing stroke cylinders
17 clamping devices
171 first clamping jaw
172 second clamping jaw
173 joint
174 semi-cylindrical holder
18 first pneumatic cylinder
19 first proximity sensor
2 bracket
21 clamping arm
22 swivel axis
23 second pneumatic cylinder
24 second proximity sensor
3 insertion rod holder
31 push rod
4 pneumatic drive means
5 cartridge
51 storage and mixing space
52 compensating piston
53 bottle neck-like section
6 tubular mixing rod
61 mixing head
62 plate-shaped coupling element
63 sealed section
B first component, basic component
H second component, hardener

1. A mixing device for preparing a ready-to-use compound comprising at least one component (B or H), which is to be mixed before use, in a cartridge (5) with a tubular mixing rod (6), wherein
the cartridge (5) has a storage and mixing space (51) with a compensating piston (52) for the at least one of the components (B or H) of the composition,
the tubular mixing rod (6) is adapted to engage in a bottle neck-like section (53) of the cartridge (5) in the storage and mixing space (51) in a rotatable and laterally displaceable manner,
the tubular mixing rod (6) has first and second ends and a mixing head (61) at its first end adapted to engage in the storage and mixing space (51) and
the tubular mixing rod (6) has a plate-shaped coupling element (62) at the second end, and further comprising
a cartridge holder (1) for receiving the cartridge (5) to be prepared,
a counter-pressure cylinder (13) assigned to the cartridge holder (1) for pressurizing a compensating piston (52) of the cartridge (5),
a mixing stroke cylinder (16) for laterally moving the cartridge holder (1),
a fixedly arranged holder (2) for the coupling element (62) of the mixing rod (6), which receives the mixing rod (6) rotatably but fixed in the longitudinal direction, and
a drive means (4) for generating a rotary movement about a longitudinal axis relative between the mixing rod (6) and the cartridge (5),
wherein the cartridge holder (1) has a clamping means (17) with which the cartridge (5) can be clamped at the bottle neck-like section (53).

2. The mixing device according to claim 1, wherein the clamping means (17) is designed to be actuatable with a first pneumatic cylinder (18).

3. The mixing device according to claim 1, wherein the clamping means (17) has two pliers jaws (171, 172) which can be pivoted about a joint (173) for the bottle neck-like section (53).

4. The mixing device according to claim 3, wherein the pliers jaws (171, 172) have approximately semi-cylindrical receptacles (174) for the bottle neck-like section (53).

5. The mixing device according to claim 1, wherein a first proximity sensor (19) is arranged on the clamping means (17), which can detect the approach of a cartridge (5) and trigger the clamping of the cartridge (5).

6. The mixing device according to claim 1, wherein at least one component (B) is accommodated in the storage and mixing space (51) and the other component (H) is accommodated in the tubular mixing rod (6), wherein an insertion rod (31) insertable in the tubular mixing rod (6), an insertion rod holder (3) for holding the insertion rod (31) and an insertion cylinder (32) associated with the insertion rod holder (3) for pressing the insertion rod (31) into the tubular mixing rod (6) are provided.

7. The mixing device according to claim 1, wherein the holder (2) for the coupling element (62) of the mixing rod (6) has at least two, preferably three, clamping arms (21) which are designed to be clamped around the plate-shaped coupling element (62) to be able to transmit a torque to the mixing rod (6).

8. The mixing device according to claim 7, wherein the clamping arms (21) are designed to be clamped around the plate-shaped coupling element (62) around pivot axes (22) arranged tangentially to the axis of rotation oriented coaxially to the mixing rod (6).

9. The mixing device according to claim 7, wherein the clamping arms (21) are designed to be actuatable via a second pneumatic cylinder (23).

10. The mixing device according to claim 7, wherein a second proximity sensor (24) is arranged on the holder (2) for the coupling element (62) of the mixing rod (6), which detects the approach of the coupling element (62) of a cartridge (5) and can trigger the clamping of the plate-shaped coupling element (62)

11. A method for operating a mixing device for preparing a ready-to-use compound comprising at least one component (B or H), which is to be mixed before use, in a cartridge (5) with a tubular mixing rod (6), wherein
the cartridge (5) has a storage and mixing space (51) with compensating piston (52) for at least one of the components (B or H) of the composition,
the tubular mixing rod (6) engages through a bottle neck-like section (53) of the cartridge (5) in a rotatable and laterally displaceable manner in the storage and mixing space (51),
the tubular mixing rod (6) has a mixing head (61) at its end in the storage and mixing space (51) and
the tubular mixing rod (6) has a plate-shaped coupling element (62) at the outer end,
with
a cartridge holder (1) for receiving the cartridge (5) to be prepared,
a counter-pressure cylinder (13) assigned to the cartridge holder (1) for pressurizing the compensating piston (52) of the cartridge (5),
a mixing stroke cylinder (16) for laterally moving the cartridge holder (1),
a fixedly arranged holder (2) for the coupling element (62) of the mixing rod (6), which receives the mixing rod (6) rotatably but fixed in the longitudinal direction, and
a drive means (4) for generating a rotary movement about a longitudinal axis relative between the mixing rod (6) and the cartridge (5),
wherein the method comprises
feeding the cartridge (5) with its bottle neck-like section (53) to a clamping means (17) of the mixing device and clamping is clamped on the bottle neck-like section (53) with this clamping means (17),
then subsequently actuating the mixing stroke cylinder (16) for moving the cartridge holder (1) with the downwardly projecting, tubular mixing rod (6) and its plate-shaped coupling element (62) until the plate-shaped coupling element (62) touches the holder (2),
wherein the plate-shaped coupling element (62) is then clamped on the holder (2) by clamping arms (21).

12. The method according to claim 11, wherein the composition (B, H) contained in the cartridge (5) in the storage and mixing space (51) is then mixed by actuating the mixing stroke cylinder (16) and a rotary drive on the holder (2).
